(19) United States
(12) Patent Application Publication
(10) Pub. No.: US 2005/0124315 A1
(43) Pub. Date: Jun. 9, 2005

(54) Operating environment setting system for mobile communications terminal

(75) Inventors: Masato Kageyama, Hiratsuka-shi (JP); Keisuke Miyata, Hiratsuka-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: KOMATSU LTD., Tokyo (JP)

(21) Appl. No.: 10/976,245

(22) Filed: Oct. 29, 2004

(30) Foreign Application Priority Data
Oct. 31, 2003 (JP) 2003-372517

(51) Int. Cl. H04B 1/04; H04B 7/185

(52) U.S. Cl. 455/403; 455/434; 455/12.1

(57) ABSTRACT

The present invention allows simple setting of the operating environment that is required when the access destination of the mobile communications terminal is altered. The mobile communications terminal mounted on the construction machinery has a satellite communications terminal and a wireless LAN terminal. When the construction machinery is disposed on a new construction site, the mobile communications terminal sends operating environment setting requests and position information from the satellite communications terminal to the control server. In response to these requests, the control server selects operating environment setting data for the wireless LAN of the construction site on the basis of the received position information, and sends this data to the satellite communications terminal of the mobile communications terminal. The mobile communications terminal automatically sets the operating environment of the wireless LAN-terminal on the basis of the received setting data. Manual setting of the operating environment is unnecessary. Subsequently, the mobile communications terminal can utilize the wireless LAN of the site.

### BACKGROUND OF THE INVENTION

1. Field of the Invention

The present invention relates to an operating environment setting system for a mobile communications terminal.

2. Description of the Related Art

In recent years, on construction sites, there has been a demand for connections to the internet, communication of surrounding image information, communication of voice information by IP (internet protocol) telephones and the like utilizing communications devices such as wireless LAN devices or the like. On construction sites, mobile machinery such as construction machinery and the like is positioned in close proximity to the worksite, and this construction machinery is suitable for the installation of communications devices. For example, if devices for internet connections and wireless LAN access devices are installed in an on-site office, and wireless LAN terminals are installed in construction machinery near the worksite, these wireless LAN terminals can be utilized as repeaters, and an internet connection environment and wireless communications between construction machinery can be realized on the construction site.

Meanwhile, in recent years, there has also been an increase in cases where the positions of construction machinery, residual fuel amounts, work records, error information and the like are transmitted by means of public mobile wireless communications such as data communications using satellite communications networks, portable telephones or the like, so that comprehensive control of construction machinery is performed (for example, see Japanese Patent Application Laid-Open No. 2002-91547 (FIG. 1)). In public mobile wireless communications, SS (spread spectrum) wireless technology using a protocol that has not been disclosed is used. In the wire communications area, special facilities are utilized for public mobile wireless communications. Accordingly, compared to wireless LAN and the like, there is little danger of information leakage. In public mobile wireless communications, the communications cost is generally based on the quantity of communication. Since the data size of information used for control purposes such as the positions of construction machinery, work records and the like is small and the frequency of communication is also low, there is no great increase in communications costs even if public mobile wireless communications are used.

However, in the case of the abovementioned image information, voice information using IP telephones or the like, multimedia information communicated by internet connections and the like, the data size is large. Furthermore, it is necessary to perform constant communications for the purpose of real time monitoring. Accordingly, if public mobile wireless communications are utilized for such purposes, the communications costs become excessively large, so that it becomes difficult to realize a system. Consequently, in cases where communications with such a large data size and high frequency of communication are performed, it is desirable to utilize a short-distance wireless communications net such as a wireless LAN or the like which has a low communications cost.

### SUMMARY OF THE INVENTION

In the case of a wireless LAN, communications can generally be performed between terminals that have the same ESS-ID (extended service set ID). Furthermore, the communications content can be enciphered between terminals that have the same WEP key (wired equivalent privacy key) by utilizing the enciphering algorithm of a secret key system. Such ESS-ID and WEP keys are set for each terminal by a manual operation such as keyboard input or the like. However, the work period from the beginning to end of a construction project is generally a short period ranging from a few weeks to a few months, so that the construction machinery moves to another construction site in a short time. Accordingly, if a wireless LAN terminal is installed on construction machinery and it is attempted to use this as a platform for wireless LAN communications, the wireless LAN terminal must be reset to suit the destination construction site each time that there is a change in the construction site where the construction machinery is located. Consequently, considerable trouble must be taken to set the operating environment of the terminal.

It is an object of the present invention to provide an operating environment setting system for a mobile communications terminal which facilitates the required operating environment setting even in cases where the access destination of the mobile communications terminal is altered.

The operating environment setting system for a mobile communications terminal provided by the present invention comprises a mobile communications terminal (31) which has a first communications terminal (17) that can communicate with an access device (83) that has the same operating environment among a plurality of access devices (83, 83, 83) having respectively different operating environments, a second communications terminal (14), and a communications controller (12) that controls said first communications terminal (17) and said second communications terminal (14); and a server (10) which can communicate with said second communications terminal (14), and which has operating environment setting data respectively corresponding to said plurality of access devices (83, 83, 83).

The communications controller (12) controls the second communications terminal (14) so that operating environment setting requests associated with designating information used to designate the desired access device (83) are sent to the abovementioned server (10). In response to the operating environment setting requests received from the second communications terminal (14), the server (10) selects operating environment setting data corresponding to the desired access device (83) designated on the basis of the designating information, and sends the selected operating environment setting data to the second communications terminal (14). In response to the operating environment setting data received from the server (10), the communications controller (12) sets the same operating environment as that of the desired access device (83) in the first communications terminal (17).

One embodiment of the present system further comprises a position information producing device (13) that produces position information for the mobile communications terminal (31). The communications controller (12) associates the position information for the mobile communications terminal (31) that is produced by the position information producing device (13) when operating environment setting requests are transmitted with the operating environment setting requests as designating information. The server (10) has position information for a plurality of access devices (83, 83, 83) associated beforehand with operating environment setting data corresponding to the plurality of access devices (83, 83, 83). Furthermore, in response to the position information for the mobile communications terminal (31) associated with the operating environment setting requests, the server (10) selects operating environment setting data corresponding to the desired access device (83) on the basis of the position information for the plurality of access devices (83, 83, 83).

In one embodiment, the communications controller (12) transmits said operating environment setting requests to said second communications terminal in response to requests from an operator. In one modification, the communications controller (12) transmits operating environment setting requests to said second communications terminal automatically in cases where communications by means of the first communications terminal (17) fail.

In one embodiment, the server (10) can not only communicate with the second communications terminal (14), but can also communicate with at least one of the plurality of access devices (83, 83, 83).

In one embodiment, said position information producing device (13) is mounted on said mobile communications terminal (31).

In one embodiment, the mobile communications terminal (31) is mounted on construction machinery (1), or is carried by a construction worker (2). The plurality of access devices (83, 83, 83) are a plurality of wireless LAN access points or routers respectively disposed on different construction sites, and the first communications terminal (17) is a wireless LAN terminal that is employed for the utilization of a plurality of wireless LANs. The second communications terminal (14) is a satellite communications terminal that is employed for the utilization of a satellite communications network. The server (10) is connected to a satellite communications network. The mobile communications terminal (31) transmits machinery information for construction machinery (1) to said server (10) via a satellite communications network, and the server (10) controls the machinery information for the construction machinery (1) that is received from the mobile communications terminal (31).

The present invention also provides a mobile communications terminal (31) which has the above-mentioned construction.

Furthermore, the present invention also provides a server (10) which has the abovementioned construction.

Moreover, the present invention also provides an operating environment setting method for a mobile communications terminal.

Furthermore, the reference numbers in parentheses in the above description merely indicate an example of a correspondence with the embodiments described below; the scope of the invention is not limited to these reference numbers.

In the present invention, the required operating environment setting can easily be accomplished even in cases where the access destination of the mobile communications terminal is altered.

### BRIEF DESCRIPTION OF THE DRAWINGS

FIG. 1 is a network diagram showing the overall construction of a mobile communications system used for construction site control which incorporates the operating environment setting system of the present invention;

FIG. 2 is a block diagram showing the construction of a portion of the operating environment setting system mounted on construction machinery 1;

FIG. 3 is a block diagram showing the functional construction of the control server 10;

FIG. 4 is a diagram showing the structure of the portion of the moving body control data base 26 that relates to the operating environment setting of the wireless LAN;

FIG. 5 is a flow chart which shows the operation of the operating environment setting system;

FIG. 6 is a flow chart which shows a modification of the operation used for the operating environment setting performed by the vehicle-mounted mobile communications terminal 31 of the construction machinery 1; and

FIG. 7 is a flow chart which shows a further modification of the modification shown in FIG. 6.

### DESCRIPTION OF THE PREFERRED EMBODIMENTS

One embodiment of the present invention will be described below with reference to the attached figures.

[Construction of a Mobile Communications System]

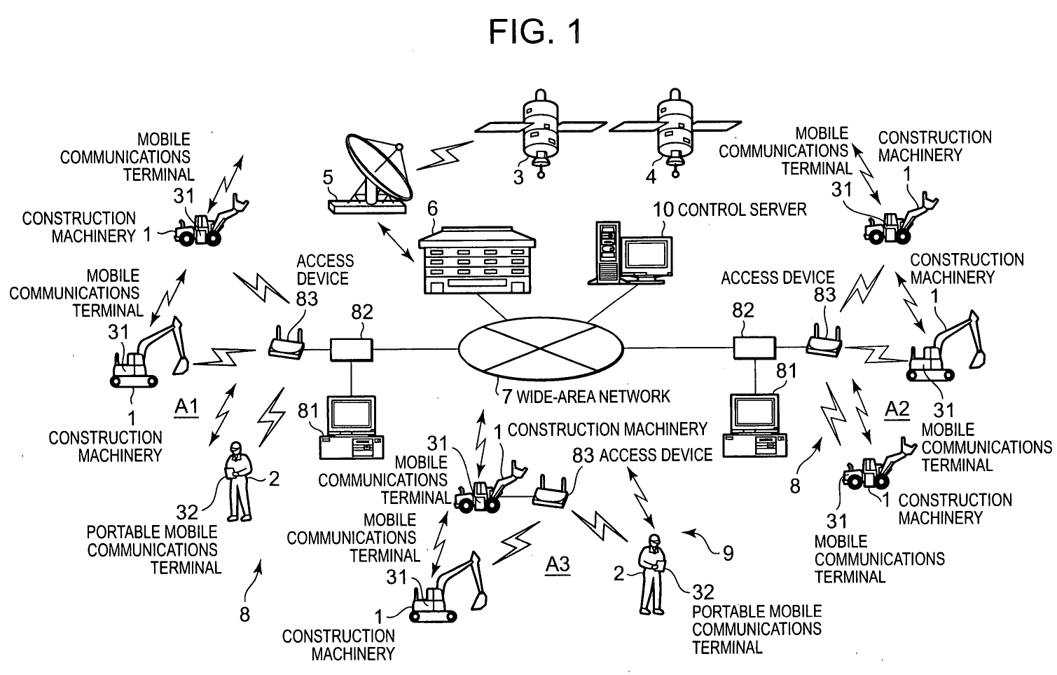

FIG. 1 shows the overall construction of a mobile communications system used for construction site control which incorporates the operating environment setting system of the present invention.

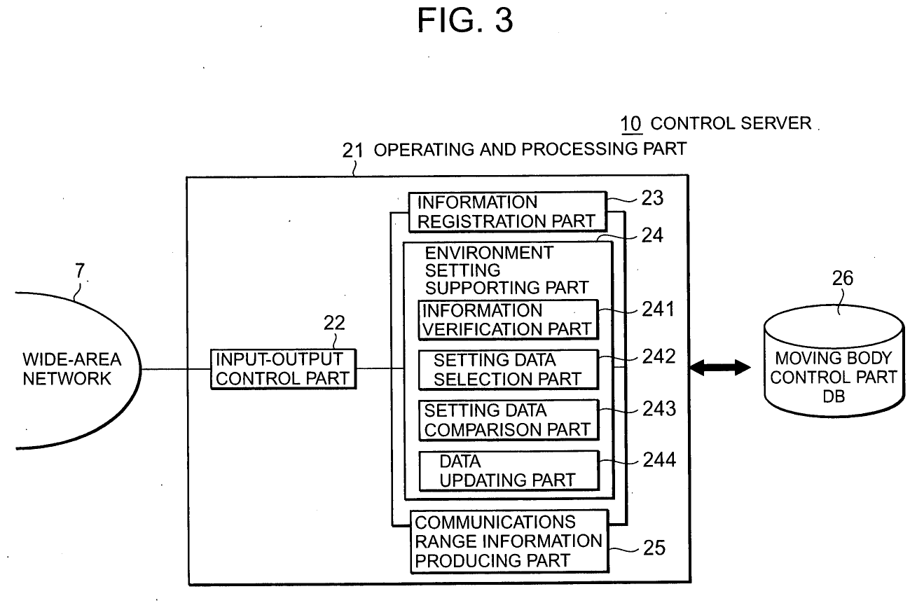

The mobile communications system shown in FIG. 1 is used (for example) to control a plurality of construction sites A1, A2 and A3 belonging to a certain construction firm (called “construction firm AA” for example). A plurality of items of construction machinery (e.g., bulldozers, hydraulic shovels, wheel loaders, dump trucks and the like) 1, 1, . . . and a plurality of workers 2, 2, . . . are present as moving bodies on the construction sites A1, A2 and A3. A mobile communications terminal 31 which will be described later with reference to FIG. 3 is mounted on each piece of construction machinery 1. Each worker 2 carries a portable mobile communications terminal (e.g., a portable telephone, mobile computer equipped with a wireless communications function or the like) 32.

On-site systems 8, 8 and 9 which perform local communications on the respective construction sites A1, A2 and A3 using wireless LANs (local area networks) are installed on the respective construction sites A1, A2 and A3. The on-site systems 8, 8 and 9 respectively have access devices 83, 83, 83 that function as wireless LAN access points or routers. In the example shown in FIG. 1, the access devices 83, 83 of the construction sites A1 and A2 are installed in fixed locations such as on-site offices, while the access device 83 of the construction site A3 is mounted inside a certain piece of construction machinery 1. Furthermore, the access devices 83, 83 of the construction sites A1 and A2 are also connected to a wide-area network (e.g., the internet) 7, while the access device 83 of the construction site A3 is not.

A satellite communications network exists as a mobile communications network that is separate from the abovementioned wireless LAN. This satellite communications network includes a communications satellite 4 and a satellite earth station 5, and is connected to a wide-area network (e.g., the internet) 7 via a network control station 6. This satellite communications network can be utilized by any of the construction sites A1, A2 and A3, and also has a higher level of communications security than the abovementioned wireless LAN. However, this satellite communications network is a public mobile wireless communications network that requires the payment of a fee, and requires the payment of a fee based on the amount of use by the construction firm AA. On the other hand, the abovementioned wireless LAN is a privately installed network that is free of charge to the construction firm AA.

The mobile communications terminals 31 that are mounted on the respective pieces of construction machinery 1 (hereafter referred to as “vehicle-mounted mobile communications terminals”) and the portable mobile communications terminals 32 that are carried by the respective workers 2 are all hybrid type terminals that can utilize both the abovementioned satellite communications network and the abovementioned wireless LAN. Specifically, these mobile communications terminals 31 and 32 all contain both a satellite communications terminal and a wireless LAN terminal. Furthermore, all of these mobile communications terminals 31 and 32 also have a position detection function that receives signals from a GPS (global positioning system) satellite 3 (only one satellite is shown in the figures; in actuality, however, a plurality of satellites are used) and calculates the current position of the device.

A control server 10 which is used for the concentrated control of the work status of the construction sites A1, A2 and A3, conditions of the construction machinery 1, 1, . . . and the like is connected to the wide-area network 7. The control server 10 collects and accumulates data such as various machinery states sensed inside the construction machinery 1, 1, . . . (e.g., current position, engine rpm, battery voltage, amount of remaining fuel, cooling water temperature, cumulative working time (service meter value), operating time and the like). The collection of this data relating machinery states that are controlled is typically performed on a periodic basis (e.g., at 24-hour intervals); if necessary, however, such collection of data may also be performed at irregular intervals. The communications used for the collection of such data relating to machinery states are typically performed utilizing a satellite communications network; however, such communications may also be performed via a wireless LAN connected to a wide-area network 7. The control server 10 may also control the operation of arbitrary construction machinery 1 by sending certain types of control commands to this construction machinery 1 by the same communications method as that described above (for example, in cases where such construction machinery 1 is stolen, this machinery 1 may be forcibly locked so that the machinery 1 will not operate). Furthermore, the control server 10 may also receive data such as reports, on-site photographs or the like from the portable mobile communications terminals 32, 32, . . . carried by the workers 2, 2, . . . by the same communications method as that described above, and may send various types of data controlled inside the control server 10 to the portable mobile communications terminals 32, 32, . . . .

As is clear from the above description, the vehicle-mounted mobile communications terminals 31, 31, . . . of the construction machinery 1, 1, . . . and the portable mobile communications terminals 32, 32, . . . carried by the workers 2, 2, . . . on any of the construction sites A1, A2 and A3 can communicate with the control server 10 on the wide-area network 7 and with various other types of servers (not shown in the figures) or moving bodies on other construction sites by utilizing the [abovementioned] satellite communications network. Furthermore, in the case of the construction sites A1 and A2, where the wireless LAN is connected to the wide-area network 7, the vehicle-mounted mobile communications terminal 31, 31, . . . and portable mobile communications terminals can also communicate with the control server 10 on the wide-area network 7 and with other devices by using the wireless LAN.

In each instance of communications, these mobile communications terminals 31, 31, . . . and 32, 32, can perform communications by selectively utilizing either the satellite communications network or wireless LAN, or by utilizing both of these networks in combination. An operating environment for the utilization of the satellite communications network and an operating environment for the utilization of the wireless LAN are set beforehand in these mobile communications terminals 31, 31, . . . and 32, 32, . . . . However, the content of the operating environment for the utilization of the wireless LAN differs according to the construction sites A1, A2 and A3. In order to allow simple setting of the operating environment used for this wireless LAN, an operating environment setting system constituting one embodiment of the present invention is incorporated into this mobile communications system. This operating environment setting system uses a control server 10, mobile communications terminals 31, 31, . . . and 32, 32, . . . and a satellite communications network.

This operating environment setting system will be described below.

When wireless LANs using access devices 83, vehicle-mounted mobile communications terminals 31 and portable mobile communications terminals 32 are constructed in the respective on-site systems 8, 8 and 9, the setting data that is required for the setting of the operating environment is supplied from the control server 10 to the vehicle-mounted mobile communications terminals 31 and portable mobile communications terminals 32 via a satellite communications network. The operating environments are automatically set in the vehicle-mounted mobile communications terminals 31 and portable mobile communications terminals 32. Accordingly, regardless of the construction site A1, A2 or A3 on which the construction machinery 1 and workers 2 are newly located, local communications by means of the wireless LAN within the respective construction sites A1, A2 and A3, and global communications by means of the wireless LAN and wide-area network 7, can easily be realized without any bothersome manual setting.

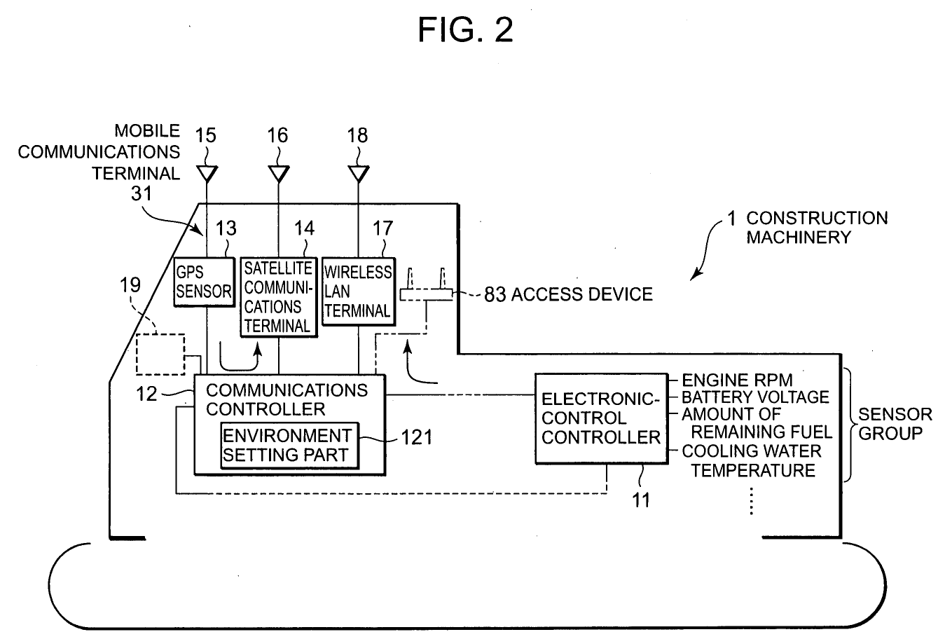

FIG. 2 shows the construction of the portions relating to the operating environment setting system mounted on the construction machinery 1.

As is shown in FIG. 2, and electronic-control controller 11 and the abovementioned mobile communications terminal 31 are mounted on the construction machinery 1. The mobile communications terminal 31 comprises a communications controller 12 that is connected to the electronic-control controller 11, a GPS sensor 13, a satellite communications terminal 14, and a wireless LAN terminal 17. The GPS sensor 13, satellite communications terminal 14 and wireless LAN terminal 17 are connected to the communications controller 12. The GPS sensor 13 has a GPS antenna 15 that is used to receive electromagnetic wave signals from the GPS satellite shown in FIG. 1 (only one satellite is shown in the figures; in actuality, however, a plurality of satellites are used). The satellite communications terminal 14 has a satellite communications antenna 16 that is used to perform communications with the communications satellite 4 shown in FIG. 1. The wireless LAN terminal 17 has a wireless LAN antenna 18 that is used to perform wireless communications with the wireless LAN access device 83. The communications controller 12 controls the GPS sensor 13, satellite communications terminal 14 and wireless LAN terminal 17.

The electronic-control controller 11 electronically controls the driving parts (e.g., engine, transmission, hydraulic system, electrical and electronic circuits and the like) of various types of construction machinery 1. Furthermore, the electronic-control controller 11 receives data indicating various states of the construction machinery 1 (e.g., engine rpm, battery voltage, amount of remaining fuel, cooling water temperature, cumulative working time (service meter value), operating time and the like) from various types of sensors attached to various parts of the construction machinery 1, and sends this machinery state data to the communications controller 12.

For example, the communications controller 12 is a computer, and has a memory device (not shown in the figures). Information such as the owner of the construction machinery 1, serial numbers belonging to the construction machinery 1, cumulative working time of the construction machinery 1, terminal ID belonging to the satellite communications terminal 14 (hereafter referred to as “satellite communications terminal ID”), terminal ID belonging to the wireless LAN communications terminal 17 (hereafter referred to as “wireless LAN terminal ID”) and the like are stored in this memory device. Furthermore, the communications controller 12 stores various types of the abovementioned machinery state data received from the electronic-control controller 11 in the abovementioned memory device. Moreover, the communications controller 12 comprises an environment setting part 121.

The environment setting part 121 is a program that controls the operating environment setting operation so as to cause the wireless LAN terminal 17 to match the wireless LAN operating environment in the respective construction sites A1, A2 and A3. The environment setting part 121 requests wireless LAN operating environment setting data from the control server 10 via the satellite communications terminal 14, receives said setting data from the control server 10 via the satellite communications terminal 14, and automatically sets the operating environment based on the received setting data in the wireless LAN communications terminal 17.

The GPS sensor 13 receives electromagnetic waves output from the GPS satellite 3 via the GPS antenna 15, and measures its own current position on the basis of the conditions of the electromagnetic waves that are received. Current position information for the construction machinery 1 measured by this GPS sensor 13 is output to the communications controller 12 and store in the memory device contained in the communications controller 12. Furthermore, in cases where a navigation system 19 is mounted on the construction machinery 1, the current position information acquired by the GPS sensor 13 is input into the navigation system 19, and is utilized there in navigation such as the display of a map indicating the current position or the like.

The satellite communications terminal 14 transmits data indicating the current position of the construction machinery 1 and data relating to the abovementioned various types of machinery states stored in the communications controller 12 to the control server 10 from the satellite communications antenna 16. Furthermore, when setting of the operating environment of the wireless LAN terminal 17 is performed, the satellite communications terminal 14 transmits operating environment setting requests to the control server 10, and receives setting data from the control server 10.

The wireless LAN terminal 17 performs communications with other vehicle-mounted mobile communications terminals 31 and portable mobile communications terminals 32 via the wireless LAN in the on-site systems 8, 8 and 9. Furthermore, in the case of the on-site systems 8, 8 that are connected to the wide-area network 7, the wireless LAN terminal 17 can communicate with the mobile communications terminals 31 and 32 installed on other construction sites, and with the control server 10 on the wide-area network or other servers, via the wide-area network 7.

The portable mobile communications terminals 32 carried by the respective workers 2 may also comprise GPS sensors, satellite communications terminals, wireless LAN terminals and communications controllers; the functions of these parts are the same as those of the corresponding parts in the vehicle-mounted mobile communications terminals 31 described above with reference to FIG. 2. Specific serial numbers, satellite communications terminal IDs and wireless LAN terminal IDs are also assigned to the portable mobile communications terminals 32. and these items are stored in memory devices contained in the portable mobile communications terminals 32. Accordingly, in the portable mobile communications terminals 32 as well, the operating environment setting of the wireless LAN terminals can be automatically performed under control similar to the control performed by the environment setting parts 121 of the vehicle-mounted mobile communications terminals 31.

Referring again to FIG. 1, the wide-area network 7 is (for example) the internet using an all-purpose protocol such as (e.g.) TCP/IP or the like. As was described above, a network control station 6, control server 10, on-site systems 8, 8 of the construction sites A1 and A2, and diverse servers (WWW servers, mail servers, FTP servers and the like, not shown in the figures) are connected to the wide-area network 7.

Each of the on-site systems 8, 8 of the construction sites A1 and A2 comprises an all-purpose computer 81 that is installed inside the site office. The computer 81 comprises a computer main body which has an operating and processing unit, a memory device and the like, input devices such as a keyboard, mouse and the like that are connected to this computer main body, and a display device such as a display or the like. This computer 81 is connected to the wide-area network (internet) via a communications control device 82 such as a modem, router or the like. Browser software which is used to show a home page or the like and email software or the like which is used to support email are installed in the computer 81 via the wide-area network (internet) 7. The computer 81 can communicate with the control server 10 and various other types of servers on the wide-area network (internet) 7 by using the abovementioned browser software, email software, special software or the like. Furthermore, a wireless LAN access device (e.g., an access point, router or the like) 83 is also installed inside the on-site office, and is connected to the wide-area network (internet) 7 via the communications control device 82.

In the on-site system 9 of the construction site A3, a wireless LAN access device 83 is mounted on a single piece of construction machinery 1. As is shown by the two-dot chain line in FIG. 2, this access device 83 is connected to a communications controller 12 inside the construction machinery 1. Accordingly, a wireless LAN is constructed with the construction machinery 1 mounting the access device 83 as a mother device. This wireless LAN is cut off from the wide-area network (internet) 7 and can be utilized only in local communications within the construction site A3. Of course such an access device 83 that is cut off from the wide-area network 3 can also be installed inside the on-site office rather than being mounted on construction machinery 1.

FIG. 3 shows the functional construction of the control server 10.

For example, the control server 10 is constructed as a WWW (world wide web) server. As is shown in FIG. 3, the control server 10 comprises an operating and processing unit 21 which executes various programs, and a memory device such as a hard disk or the like which stores information that is transmitted and received.

The operating and processing unit 21 has an input-output control device 22 which controls the input and output of data between the wide-area network 7 and the operating and processing unit 21. Furthermore, the operating and processing unit 21 has an information registration part 23, an environment setting supporting part 24 and a communications range information producing part 25 which are programs that are opened on the data base control system. A moving body control data base (DB) 26 in which data used to control machinery information for the construction machinery 1, 1, . . . and to support the setting of the wireless LAN operating environment is accumulated is constructed in the memory device of the operating and processing unit 21.

The input-output control part 22 controls the data that is input and output via the wide-area network 7. In concrete terms, the input-output control part 22 performs input control of data such as machinery states, reports and the like arriving from the vehicle-mounted mobile communications terminals 31 of the construction machinery 1, 1, . . . and the portable mobile communications terminals 32 held by the workers 2, 2, . . . , output control of wireless LAN operating environment setting data that is to be sent to the vehicle-mounted mobile communications terminals 31 and portable mobile communications terminals 32 via the satellite communications network or the wireless LAN, input-output control of various other types of data communicated with the on-site systems 8, 8 of the construction sites A1 and A3 via the wide-area network 7 and the like.

The information registration part 23 registers the respective serial numbers, satellite communications terminal IDs and wireless LAN terminal IDs of the construction machinery 1 (vehicle-mounted mobile communications terminals 31) and portable mobile communications terminals 32 in the control server 10 (moving body control data base 26). For example, in cases where AA Construction newly purchases or leases certain construction machinery 1, AA Construction can register the serial number, satellite communications terminal ID and wireless LAN terminal ID of this construction machinery 1 in the control server 10 in association with a user ID and password assigned to AA Construction beforehand by means of an input operation from a suitable terminal connected to the wide-area network 7. Furthermore, the information registration part 23 can also register position information (e.g., information acquired by the GPS) for the access devices 83 of the construction sites A1, A2 and A3, wireless LAN group IDs (hereafter referred to as “LAN-IDs”), code deciphering keys, customer names, site names and the like in the control server 10, and can alter such information as required. Such registration and alteration can be accomplished by an input operation from the same terminal as that described above.

Here, the LAN-ID of the abovementioned wireless LAN group is (for example) an ESS-ID (extended service set ID), and is a distinction that is required so that the LANs to which the mobile communications terminals 31, 32 respectively belong can be distinguished. Furthermore, the code deciphering key is (for example) a WEP key (wired equivalent privacy key), and is used to decipher data that is transmitted in enciphered form for reasons of security. When an operating environment setting request arrives from a certain mobile communications terminal 31 or 32, the control server 10 determines the wireless LAN group to which this mobile communications terminal 31 or 32 belongs, and then transmits a LAN-ID and code deciphering key that have been assigned to this wireless LAN group beforehand to the mobile communications terminal 31 or 32 as setting data. In the mobile communications terminal 31 or 32, the received LAN-ID and code deciphering key are automatically set in the wireless LAN terminal (in other words, the operating environment of the wireless LAN is set automatically). As a result, the mobile communications terminal 31 or 32 can communicate in the wireless LAN groups to which this terminal belongs). In this case, the satellite communications network, which can be used in any of the construction sites, is used for the transmission of operating environment setting requests and the associated setting data.

The environment setting supporting part 24 comprises an information verification part 241, a setting data selection part 242, a setting data comparison part 243, and a data updating part 244. The environment setting supporting part 24 starts in response to an operating environment setting request from the mobile communications terminal 31 or 32.

The information verification part 241 compares the user ID, password 10, machinery serial number and wireless LAN terminal ID that are transmitted together with operating environment setting requests from the mobile communications terminal 31 or 32 via the satellite communications network with the same items registered beforehand in the control server 10, and verifies these items. In cases where this verification is not obtained, the setting data required for the setting of the operating environment is not transmitted.

The setting data selection part 242 judges which access device 83 (of the construction sites A1, A2 and A3) can be communicated with by the mobile communications terminal, or which access device 83 (of the construction sites A1, A2 and A3) is closest to the mobile communications terminal in terms of position, on the basis of position information for the mobile communications terminal 31 or 32 that is transmitted along with the abovementioned various types of data together with the operating environment setting requests, extracts the LAN-ID and code deciphering key of the wireless LAN constructed on this site from data stored beforehand, and selects this data as the setting data.

The setting data comparison part 243 compares the newly selected data and the setting data already set in the mobile communications terminal 31 or 32 (i.e., stored in the control server 10). In cases where the newly selected data is found to differ fro the existing data as a result of the abovementioned comparison, the data updating part 244 updates the content stored in the control server 10 (moving body control data base 26) to the newly set data, outputs the newly set data to the input-output control part 22, and causes this data to be transmitted to the mobile communications terminal 31 or 32.

In cases where the mobile communications terminal 31 or 32 moves to another site, the abovementioned comparison will show that the newly set data and the existing set data differ. In such a case, the newly set data is transmitted to the mobile communications terminal 31 or 32, and operating environment setting is performed so that the newly set data becomes effective. On the other hand, in cases where the results of the abovementioned comparison show that the newly set data and the existing set data are the same, the transmission of the newly set data is canceled, so that the existing set data remains effective in the mobile communications terminal 31 or 32. Usually, the mobile communications terminal 31 or 32 is located on the same site for a period of several weeks to several months. While the mobile communications terminal 31 or 32 is located on the same site, needless processing involving the transmission or updating of setting data is omitted.

The communications range information producing part 25 transmits information indicating the extent of the communications range from the access device 83 in which the mobile communications terminal is located in a state in which the operating environment setting of the mobile communications terminal 31 or 32 is completed so that communications by means of the wireless LAN are possible. For example, communications with the access device 83 ordinarily have a communications range with a radius of approximately 1 km. The communications range information producing part 25 monitors the position information that is sent via the satellite communications network from the mobile communications terminal 31 or 32, and informs the mobile communications terminal 31 or 32 via the satellite communications network as to whether the mobile communications terminal 31 or 32 is inside this communications range or outside this communications range. Furthermore, in cases where the mobile communications terminal 31 or 32 is in a position where the terminal is about to leave the communications range, or is in a position that is outside the communications range, the communications range information producing part transmits a message indicating this to the mobile communications terminal 31 or 32. Moreover, in cases where a wireless LAN group that can be utilized is present nearby when the mobile communications terminal 31 or 32 is outside the communications range, the communications range information producing part 25 transmits a message indicating this to the mobile communications terminal 31 or 32, and urges resetting of the operating environment.

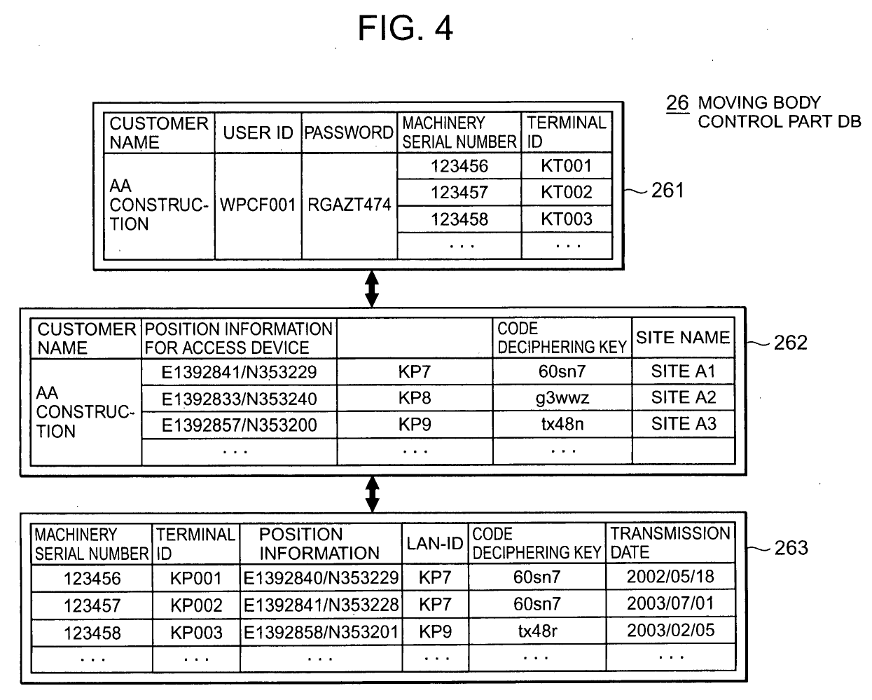

FIG. 4 shows the structure of the portion of the moving body control data base 26 that relates to the operating environment setting of the wireless LAN.

As is shown in FIG. 4, the moving body control data base 26 is a relational data base which includes a plurality of tables such as a user control table 261, and access device control table 262, a setting data control table 263 and the like.

The names of customers utilizing this system (e.g., “construction firm AA”), user ID and passwords assigned to these customers, and machinery serial numbers, wireless LAN terminal ID and the like of construction machinery 1, 1, . . . (vehicle-mounted mobile communications terminals 31, 31, . . . ) and portable mobile communications terminals 32, 32, . . . used by the customers are recorded in the user control table 261.

Customer names, position information for access devices 83, 83, 83 of user construction sites A1, A2 and A3, LAN ID and code deciphering keys assigned to the wireless LAN groups of the access devices, names of the construction sites A1, A2 and A3 and the like are recorded in the access device control table 262.

The setting data control table 263 is a table which controls the setting conditions of the operating environment of the wireless LAN in the construction machinery 1, 1, . . . (vehicle-mounted mobile communications terminals 31, 31, . . . ) and portable mobile communications terminals 32, 32, . . . . The serial numbers of the construction machinery 1, 1, . . . (vehicle-mounted mobile communications terminals 31, 31, . . . ) and portable mobile communications terminals 32, 32, . . . , wireless LAN terminal IDs (indicated simply as “terminal IDs” in FIG. 4), position information, LAN-IDs (selected on the basis of the abovementioned position information) and code deciphering keys of the wireless LAN groups to which the mobile communications terminals belong, final transmission date of the setting data (LAN-IDs and code deciphering keys) and the like are recorded in the setting data control table 263.

[Operation of System]

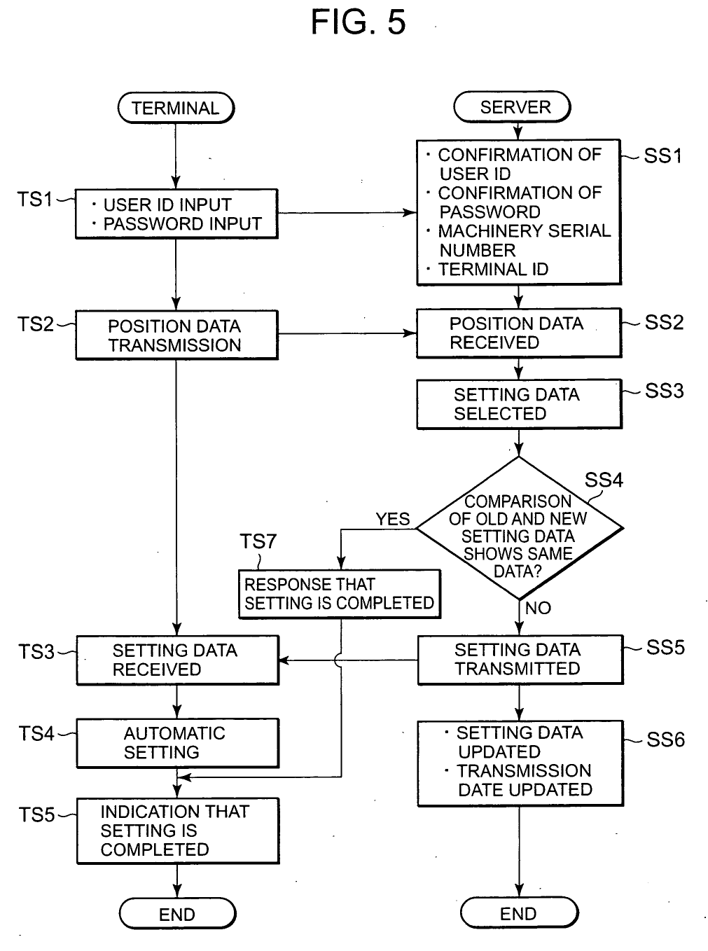

Next, the operation of this operating environment setting system will be described with reference to FIG. 5.

FIG. 5 shows the flow of the processing that is performed in a case where the operating environment for wireless LAN is set in certain construction machinery 1 used by construction firm AA. In FIG. 5, the flow beginning from the terminal shown as “terminal” indicates processing that is performed by the vehicle-mounted mobile communications terminal 31 of the construction machinery 1, and the flow that begins from the terminal shown as “server” indicates processing that is performed by the control server 10.

It is assumed here that a user ID and password are assigned to the construction firm AA beforehand, and that the machinery serial number and wireless LAN terminal ID of this construction machinery 1 (vehicle-mounted mobile communications terminal 31) are registered in the control server.

[Step TS1 on the Side of the Vehicle-Mounted Mobile Communications Terminal 31]

When the construction machinery 1 is newly located on any of the construction sites A1, A2 or A3, there is a need to perform operating environment setting of the wireless LAN terminal 17 in order to perform communications using the wireless LAN of the construction site A1, A2 or A3. Accordingly, the operator of the construction machinery 1 starts the environment setting part 121 inside the communications controller 12 by operating the vehicle-mounted mobile communications terminal 31 of the construction machinery 1. The environment setting part 121 displays a menu screen on the display screen of the navigation system 19, the display screen of the vehicle-mounted mobile communications terminal 31 or the like. The operator selects the operating environment settings from the menu screen. The environment setting part 121 that has received an operating environment setting request urges the operator to input the user ID and password, and the operator inputs these items. The environment setting part 121 outputs the input user ID and password to the satellite communications terminal 14 together with the operating environment setting request. The satellite communications terminal 14 transmits the user ID, password and operating environment setting request to the control server 10 via the satellite communications network. Here, the operating environment setting request contains the machinery serial number and wireless LAN terminal ID of the construction machinery 1 (vehicle-mounted mobile communications terminal 31) along with a command code that indicates an operating environment setting request.

[Step SS1 on the Side of the Control Server 10]

In the control server 10, the information verification part 241 of the environment setting supporting part 24 starts in response to the received operating environment setting request. The information verification part 241 checks whether the received user ID, password, machinery serial number and wireless LAN terminal ID are in a correct relationship by referring to the user control table 261 inside the moving body control data base 26. If this information is correct, construction machinery position information is requested for the construction machinery 1 (vehicle-mounted mobile communications terminal 31) via the satellite communications network. Hereafter, communications between the construction machinery 1 (vehicle-mounted mobile communications terminal 31) and control server 10 are performed using the satellite communications network.

[Step TS2]

In the construction machinery 1 (vehicle-mounted mobile communications terminal 31), the environment setting part 121 acquires position information from the GPS sensor 13 in response to the request from the control server 10, and transmits this information to the control server 10.

[Step SS2]

In the control server 10, the setting data selection part 242 starts, associates the position information received from the construction machinery 1 (vehicle-mounted mobile communications terminal 31) with the machinery serial number and wireless LAN terminal ID of the construction machinery 1 (vehicle-mounted mobile communications terminal 31), and records this information in the setting data control table 261 shown in FIG. 4.

[Step SS3]

Subsequently, the setting data selection part 242 refers to the position information for the access devices 83, 83, 83 in the access device control table 262, selects the access device 83 with the position information that is closest to the received position information for the construction machinery 1, and selects the LAN-ID and code deciphering key assigned to the selected access device 83 from the access device control table 262 as the setting data.

[Step SS4]

Subsequently, the setting data comparison part 243 starts, and compares the setting data that is selected in step SS3 and the setting data that has already been set in the setting data control table 23 in correspondence with the machinery serial number of the construction machinery 1.

[Steps SS5 and SS6]

If the respective sets of data are found to be different as a result of the abovementioned comparison, The input-output control part 22 transmits the new setting data to the side of the construction machinery 1. Then, the data updating part 244 rewrites the setting data corresponding to the machinery serial number of the construction machinery 1 in the setting data control table 263 as the new setting data, and also updates the transmission date.

[Steps TS3 and TS4]

Meanwhile, in the construction machinery 1 (vehicle-mounted mobile communications terminal 31), the environment setting part 121 automatically performs the operating environment setting of the wireless LAN terminal 17 using the received setting data (i.e., sets the received setting data in the wireless LAN terminal 17).

[Step TS5]

When the operating environment setting is completed, the environment setting part 121 informs the operator by displaying a message indicating that the setting has been completed on the abovementioned display screen.

[Step TS7]

In cases where it is judged that the selected setting data is the same as the existing setting data in step SS4 in the control server 10, the setting data comparison part 243 transmits a message indicating this to the construction machinery 1 (vehicle-mounted mobile communications terminal 31), and the setting operation performed by the environment setting part 121 is canceled. Furthermore, in this case as well, the transmission date inside the setting data control table 263 is not updated.

Thus, regardless of the construction site A1, A2 or A3 on which the construction machinery 1 is located, the vehicle-mounted mobile communications terminal 31 of the construction machinery 1 can sent operating environment setting requests and current position information to the control server 10 via the satellite communications network, which can be utilized on any of the construction sites A1, A2 or A3. On the basis of this current position information, the control server 10 selects setting data for the wireless LAN of the construction site A1, A2 or A3 on which the construction machinery 1 is located, and transmits the selected setting data to the vehicle-mounted mobile communications terminal 31 via the satellite communications network. On the basis of this setting data, the vehicle-mounted mobile communications terminal 31 automatically performs the operating environment setting of the wireless LAN terminal 17. Subsequently, the vehicle-mounted mobile communications terminal 31 can perform communications utilizing the wireless LAN of the construction site A1, A2 or A3 on which this construction machinery 1 is located. Regardless of the construction site A1, A2 or A3 to which the construction machinery 1 moves, there is no need for manual setting of the operating environment of the wireless LAN.

Furthermore, the operating environment of the wireless LAN can be simply set by an operation similar to that described above in the portable mobile communications terminals 32 carried by the respective workers 2 as well.

As a result of the message transmission function of the communications range information producing part 25 of the control server 10, an appropriate response can easily be taken in cases where the construction machinery 1 or workers 2 are about to leave the wireless LAN communications range, or in cases where the construction machinery 1 or workers 2 are already outside this range.

By utilizing the wireless LAN, communications costs can be greatly reduced in cases where data of a large size is frequently communicated on the construction sites A1, A2 and A3. The communication of data whose size is not very large and whose communication frequency is also low, such as machinery state data of the construction machinery 1, can also be accomplished using the wireless LAN.

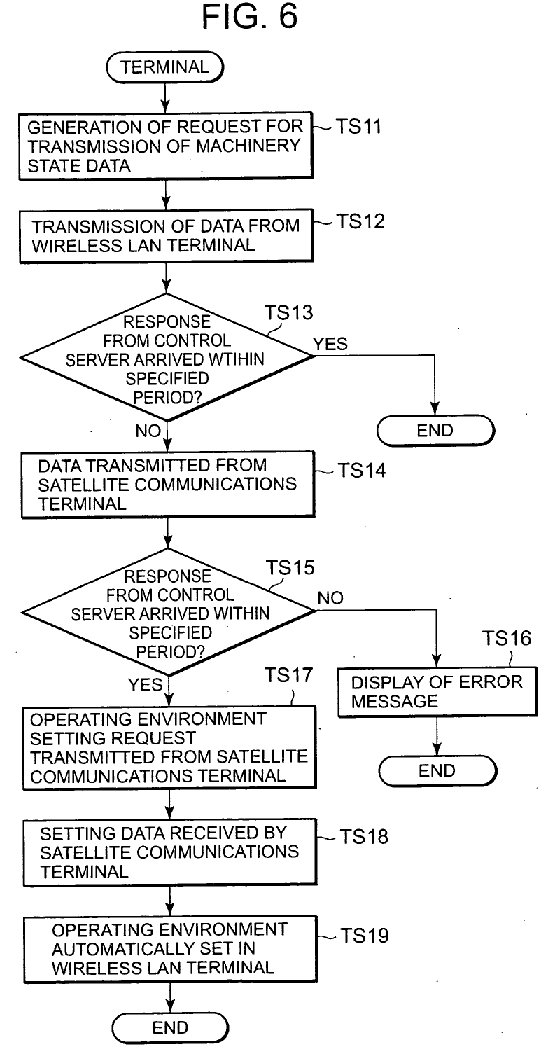

FIG. 6 shows the flow of a modification of the operation used to set the operating environment of the wireless LAN that is performed by the vehicle-mounted mobile communications terminal 31 of the construction machinery 1. In this modification, the mobile communications terminal 31 automatically detects that movement to another construction site has occurred, and sends an operating environment setting request to the control server 10; there is no need for any operation by the operator. Such an operation can be performed not only in the mobile vehicle-mounted mobile communications terminal 31 of the construction machinery 1, but also in the portable mobile communications terminals 32 held by the workers 2.

In step TS11, as is shown in FIG. 6, a request for the transmission of machinery state data for the construction machinery 1 to the control server 10 is generated inside the communications controller 12 of the vehicle-mounted mobile communications terminal 31. As has already been described above, this transmission request may be generated periodically (e.g., every 24 hours), or may be generated by the occurrence of a specified event such as the occurrence of trouble inside the construction machinery 1. In either case, when a machinery state data transmission request is generated, the communications controller 12 transmits the stored machinery state data from the wireless LAN terminal 17 to the control server 10 via the wireless LAN in step TS12.

Subsequently, in step TS13, the communications controller 12 checks whether or not a response from the control server 10 has been received by the wireless LAN terminal 17 within a specified time from the data transmission performed by the wireless LAN terminal 17. As a result, if a response has been received, this means that communications with the control server 10 using the wireless LAN have been successfully accomplished; accordingly, control is ended.

On the other hand, in cases where it is determined as a result of the check performed in step TS13 that no response has been received, this means that communications with the control server 10 using the wireless LAN have failed. Such a case occurs when the construction machinery 1 moves to another construction site. In such a case, the communications controller 12 transmits the stored machinery state data to the control server 10 from the satellite communications terminal 14 via the satellite communications network in step TS14.

Subsequently, in step TS15, the communications controller 12 checks whether or not a response from the control server 10 has been received by the satellite communications terminal 14 within a specified time from the data transmission performed by the satellite communications terminal 14. If it is determined as a result that a response has been received, this indicates that communications with the control server 10 using the satellite communications network have been successful. In this case, in step TS17, the communications controller 12 transmits an operating environment setting request to the control server 10 from the satellite communications terminal 14 via the satellite communications network.

Subsequently, although this is not shown in FIG. 6, an operation similar to that of step TS2 and steps SS2 through SS5 shown in FIG. 5 is performed; as a result, setting data from the control server 10 is received by the satellite communications terminal 14 in step TS1 shown in FIG. 6. In step TS19, the communications controller 12 automatically sets the operating environment in the wireless LAN terminal 17 using the received setting data.

After the operating environment has thus been set in the wireless LAN terminal 17, as long as the construction machinery 1 is located on the same construction site, when subsequent requests for the transmission of machinery state data are generated, the machinery state data can be sent using the wireless LAN.

Furthermore, in the abovementioned step TS15, in cases where a response from the control server 10 is not obtained even via satellite communications, this means that there is a possibility that trouble has occurred in the control server 10 or one of the communications networks. In this case, the communications controller 12 displays an error message on the abovementioned display screen, and control is ended.

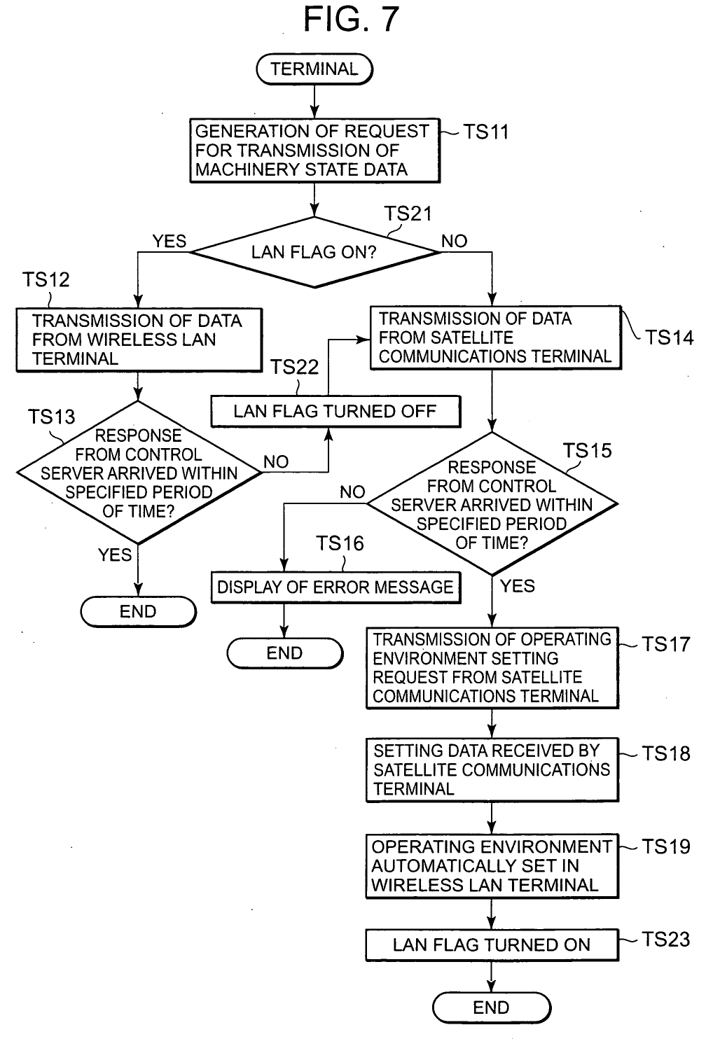

FIG. 7 shows a further modification of the modification shown in FIG. 6. In FIG. 7, steps that are the same as those shown in FIG. 6 are labeled with the same reference symbols, and a redundant description is omitted.

In the operation shown in FIG. 6, in cases where a machinery state data transmission request is generated, communications by wireless LAN are first performed, and an environment setting using satellite communications is performed when such wireless LAN communications fail. In the operation shown in FIG. 7, on the other hand, information (a LAN flag) indicating whether or not operating environment setting of the wireless LAN has been completed is controlled, and in cases where a machinery state data transmission request is generated, the wireless LAN or satellite communications are selected in accordance with this information.

As is shown in FIG. 7, when a machinery state data transmission request is generated in step TS11, the communications controller 12 checks the LAN flag stored inside the communications controller 12 in step TS21. In cases where it is indicated as a result that the LAN flag is ON (i.e., that operating environment setting has been completed), the processing proceeds to step TS12, and the machinery state data is transmitted via the wireless LAN. Subsequently, control similar to that of the flow shown in FIG. 6 is performed. However, in this flow, in cases where communications by means of the wireless LAN fail in step TS13, the communications controller 12 sets the LAN flag at OFF (operating environment setting not completed) in step TS22. Then, when the operating environment of the wireless LAN is set in step TS19, the communications controller 12 sets the LAN flag at ON (operating environment setting completed) in step TS23.

In the operation shown in FIG. 6 or FIG. 7, when a machinery state data transmission request is generated, a check as to whether or not the operating environment is correctly set in the wireless LAN terminal 17 is automatically made, and if this environment is not set, setting is automatically performed. However, as still another modification, the system may also be devised so that a check as to whether or not the operating environment is correctly set in the wireless LAN terminal 17 is automatically made by trying communications by means of the wireless LAN at a different timing than the generation of machinery state data transmission requests. Alternatively, the system may also be devised so that a check as to whether or not the operating environment is correctly set in the wireless LAN terminal 17 is automatically made by trying preparatory communications such as a handshake prior to the transmission of the machinery state data at the time that machinery state data transmission requests are generated.

An embodiment and modifications of the present invention have been described above. However, the scope of the present invention is not limited to the abovementioned embodiment; various modifications and improvements within limits that involve no departure from the gist of the present invention are also included in the present invention.

For example, although a single access device 83 is disposed in a single wireless LAN group in the above embodiment, a plurality of access devices 83 with the same LAN-ID and code deciphering key may be disposed, thereby the communication range of the same LAN groups can be extended.

Furthermore, a plurality of access devices 83 with different LAN-IDs and code keys may be disposed so that the communications ranges of these access devices are overlapped or superimposed. In cases where a plurality of construction firms or the like are using the same construction site, wireless LANs of different firms can be independently utilized on the same construction site by causing the LAN-[ID] and code key to differ for each firm.

In the above embodiment, in cases where the control server 10 sends setting data to a certain mobile communications terminal 31 or 32, the setting data of the wireless LAN to which the mobile communications terminal 31 or 32 belongs is selected and transmitted. However, as a modification, it would also be possible to devise the system so that setting data for a plurality of different wireless LANs is combined and transmitted to the mobile communications terminal 31 or 32, the mobile communications terminal 31 or 32 selects the setting data for the specified wireless LAN to which this terminal currently belongs from the stored sets of different setting data, and this data is set in the wireless LAN terminal 17.

The present invention can be used not only for the setting of the operating environment of wireless LAN terminals, but also for the purpose of setting the operating environment of various other types of communication terminals used in networks, whether wire-based or wireless. Communications networks that can be utilized for operating environment setting include types of networks other than satellite communications networks (e.g., portable telephone communications networks or the like).

The present invention is not limited to construction machinery or workers, but can also be used for wireless communications between buses, training vehicles, railroad cars, ships, aircraft and the like that move through specified areas.

1. An operating environment setting system for a mobile communications terminal comprising:
a mobile communications terminal which has a first communications terminal that can communicate with an access device that has the same operating environment among a plurality of access devices having respectively different operating environments, a second communications terminal, and a communications controller that controls said first communications terminal and said second communications terminal; and
a server which can communicate with said second communications terminal, and which has operating environment setting data respectively corresponding to said plurality of access devices;
wherein said communications controller controls said second communications terminal so that operating environment setting requests associated with designating information used to designate the desired access device are sent to said server;
said server responds to said operating environment setting requests received from said second communications terminal, selects said operating environment setting data corresponding to said desired access device designated on the basis of said designating information, and sends said selected operating environment setting data to said second communications terminal; and
said communications controller responds to said operating environment setting data received from said server, and sets the same operating environment as that of said desired access device in said first communications terminal.

2. The operating environment setting system according to claim 1, further comprising:
a position information producing device which produces position information for said mobile communications terminal;
wherein said communications controller associates the position information for said mobile communications terminal that is produced by said position information producing device when said operating environment setting requests are transmitted with said operating environment setting requests as said designating information;
said server holds position information for said plurality of access devices in association with operating environment setting data corresponding to said plurality of access devices; and
said server selects said operating environment setting data corresponding to said desired access device on the basis of position information for said plurality of access devices in response to position information for said mobile communications terminal associated with said operating environment setting requests.

3. The operating environment setting system according to claim 1, wherein said communications controller transmits said operating environment setting requests to said second communications terminal in response to requests from an operator.

4. The operating environment setting system according to claim 1, wherein said communications controller transmits said operating environment setting requests to said second communications terminal automatically in cases where communications by means of said first communications terminal fail.

5. The operating environment setting system according to claim 1, wherein said plurality of access devices are different wireless LAN access points or routers, and said first communications terminal is a wireless LAN terminal used for the utilization of said wireless LAN.

6. The operating environment setting system according to claim 1, wherein said second communications terminal is a satellite communications terminal used for the utilization of a satellite communications network.

7. The operating environment setting system according to claim 1, wherein said server can not only communicate with said second communications terminal, but can also communicate with at least one of said plurality of access devices.

8. The operating environment setting system according to claim 1, wherein said position information producing device is mounted on said mobile communications terminal.

9. The operating environment setting system according to claim 1, wherein a mobile communications terminal is mounted on construction machinery or carried by a construction worker, said plurality of access devices are a plurality of wireless LAN access points or routers that are respectively located at different construction sites, said first communications terminal is a wireless LAN terminal that is used for the utilization of said plurality of wireless LANs, said second communications terminal is a satellite communications terminal that is used for the utilization of a satellite communications network, said server is connected to said satellite communications network, said mobile communications terminal transmits machinery information for said construction machinery to said server via said satellite communications network, and the server controls the machinery information for said construction machinery that is received from said mobile communications terminal.

10. A mobile communications terminal comprising:
a first communications terminal which can communicate with an access device that has the same operating environment among a plurality of access devices that respectively have different operating environments;
a second communications terminal which can communicate with a server that has operating environment setting data respectively corresponding to said plurality of access devices; and
a communications controller that controls said first communications terminal and said second communications terminal;
wherein said communications controller is devised so that (A) said second communications terminal is controlled in such a manner that operating environment setting requests associated with designating information used to designate the desired access device is sent to said server, (B) said operating environment setting data corresponding to said desired access device that is sent back to said second communications terminal by said server in response to said operating environment setting requests is received, and (C) the same operating environment as that of said desired access device is set in said first communications terminal in response to said operating environment setting data received from said server.

11. A server used to support the operating environment setting of a mobile communications terminal, comprising:
a processing device which can communicate with a mobile communications terminal having a first communications terminal that can communicate with an access device having the same operating environment among a plurality of access devices that have respectively different operating environments, and a second communications terminal; and
a memory device which has operating environment setting data respectively corresponding to said plurality of access devices;
wherein said processing device is devised so that (A) operating environment setting requests associated with designating information that is used to designate a desired access device are received from said second communications terminal of said mobile communications terminal, (B) said operating environment setting data corresponding to said desired access device designated on the basis of said designating information is selected in response to said operating environment setting requests received from said second communications terminal, and (C) said selected operating environment setting data is sent to said second communications terminal, and as a result, the same operating environment as that of said desired access device is set in said first communications terminal by said mobile communications terminal.

12. An operating environment setting method for a mobile communications terminal having a first communications terminal that can communicate with an access device having the same operating environment among a plurality of access devices that have respectively different operating environments, and a second communications terminal, comprising the steps of:
storing operating environment setting data respectively corresponding to said plurality of access devices by means of a server that can communicate with said second communications terminal;
sending operating environment setting requests associated with designating information used to designate a desired access device to said server by means of said second communications terminal of said mobile communications terminal;
selecting said operating environment setting data corresponding to said desired access device in response to said operating environment setting requests received from said second communications terminal, and sending said selected operating environment setting data to said second communications terminal, by means of said server; and
setting the same operating environment as that of said desired access device in said first communications terminal in response to said operating environment setting data received by said second communications terminal, by means of said mobile communications terminal.
